(19) United States
(12) Patent Application Publication
(10) Pub. No.: US 2022/0266202 A1
(43) Pub. Date: Aug. 25, 2022

(54) Light Curing for Membrane Performance

(71) Applicant: Aqua Membranes Inc., Albuquerque, NM (US)

(72) Inventors: Rodney E Herrington, Albuquerque, NM (US); Craig Beckman, Albuquerque, NM (US)

(21) Appl. No.: 17/627,586

(22) PCT Filed: Aug. 6, 2020
(86) PCT No.: PCT/US2020/045198

§ 371 Date: Jan. 14, 2022

Related U.S. Application Data
(60) Provisional application No. 62/885,453, filed on Aug. 12, 2019.

(51) Int. Cl. B01D 67/00; B01D 63/10

(52) U.S. Cl. CPC B01D 67/009; B01D 63/10; B01D 67/0006; B01D 2313/146; B01D 2321/343; B01D 2323/345; B01D 2323/42

(57) ABSTRACT

The present invention relates to a spiral wound membrane element designs wherein the membrane sheet is fabricated with selective flux and rejection characteristics that can then be modified using various intensities and wavelengths of energy such as UV or the visible spectrum to optimize characteristics of the membrane sheet such as flux or rejection, and that can be utilized to optimally bond photopolymer spacers either above the active surface of the membrane sheet, or below the active surface.

### TECHNICAL FIELD

The subject invention relates to a membrane system utilized for the separation of fluid components, specifically spiral-wound membrane elements.

### BACKGROUND ART

Spiral-wound membrane filtration elements are known in the art, and typically comprise a laminated structure, referred to as a leaf, comprised of a membrane sheet sealed to or around a permeable permeate carrier on three sides. The permeable permeate carrier extends beyond the membrane envelope at one end and wraps around the center tube which creates a path for removal of permeate fluid perpendicular to the axis of the center tube, through holes in the center tube, and out the end of the center tube. The laminated structure is wrapped spirally around the central tube and spaced from itself with a permeable feed spacer to allow axial flow of the feed fluid through the element from the feed to the reject end of the spiral wound element. Traditionally, a feed spacer is used to allow flow of the feed water, some portion of which will pass through the membrane, into the spiral wound element and allow reject water to exit the element in a direction parallel to the center tube and axial to the element construction. Some spiral-wound membrane filtration elements employ a single leaf, while others comprise multiple leave all wound spirally around the center tube. In some configurations the leaves are relatively square, meaning that the leaf width is relatively close to the leaf width. This is typically the case for common 40″ long elements of standard diameters such as 2.5″, 4″, 8″, and 16″. In other configurations, particularly for smaller spiral wound membrane elements which are shorter in length than 40″ such as those used in residential or light commercial applications, the membrane leaves are longer in the dimension perpendicular to the center tube than in the dimension parallel to the center tube, the typical axis along which cross flow occurs. In some cases the length of the leaves in such configurations are as much as three times or more than the leaf width. It is rare that elements are made in configurations where the leaf length is significantly less than the leaf width.

Improvements to the design of spiral wound elements have been disclosed in U.S. Pat. No. 6,632,357 to Barger et al., U.S. Pat. No. 7,311,831 to Bradford et al., and patents in Australia (2014223490) and Japan (6499089) entitled “Improved Spiral Wound Element Construction” to Roderick et al. which replace the conventional feed spacer with islands or protrusions either deposited or embossed directly onto the inside or outside surface of the membrane. Typically, fluid feed flow is normal to the center tube of the spiral wound element. In fabrication, after winding the element in the spiral configuration, the membrane sheet envelope is cut off after gluing and the feed edge of the membrane envelope presents a flat surface to the flow of feed solution. Provisional patent application number 62849952 entitled “Entrance Features in Spiral Wound Elements” to Beckman, et al., describe tapered leading edges of the membrane sheet envelope. PCT patent application PCT/US2018/016318 entitled “Graded Spacers for Filtration Wound Elements” to Roderick, et al., describe feed spacer features that have variable heights down the length of the feed space and permeate carrier spaces. US patent application PCT/US17/62425 entitled “Flow Directing Devices for Spiral Sound Elements” to Herrington, et al., describe anti-telescoping devices that incorporate turning vanes to cause fluid flow to sweep the feed end of the spiral wound element to help avoid blockage of particles in the feed stream from impinging on the end of the membrane envelope.

In the fabrication of printed spacers rather than mesh spacers, various adhesives are used to create the feed space components that are bonded to the membrane sheet active surface. In other applications, the feed space components are attached to the inactive side of the membrane sheet. In many of these cases, the adhesive applied to the membrane to create the feed space comprises a photopolymer that is rapidly cured by applying ultraviolet radiation (UV) energy to the photopolymer material so that it will cure rapidly and take a set physical shape. Depending on the composition of the polymer membrane surface, UV exposure can change the characteristics of the flux and salt rejection characteristics of the active polymer coating. In some cases, UV exposure can be detrimental to flux and rejection. In other cases, UV energy can improve the characteristics of flux by increasing the flux, or by improving the rejection. In this case, salt rejection of the membrane sheet can be increased so that the efficiency of membrane is improved by producing a better quality product fluid, one that has fewer salt ions.

### Disclosure of Invention

Understanding of the present invention can be facilitated by the context of U.S. Pat. No. 6,632,357 to Barger et al., U.S. Pat. No. 7,311,831 to Bradford et al., and patents in Australia (2014223490) and Japan (6499089) entitled “Improved Spiral Wound Element Construction” to Roderick et al., each of which is incorporated herein by reference.

Many design parameters of spiral-wound elements affect element performance. Fluid flow characteristics such as flow velocity, flow channel shape, and feed spacer geometry affect residence time, shear, and turbulence which in turn influence performance characteristics such as membrane flux, rejection and recovery rate of a membrane system. “Recovery” of a spiral-wound filtration element is defined as the ratio of permeate flow to feed flow in the membrane element. Typical single element recovery for reverse osmosis elements currently in use ranges from 10% to 30%, meaning that 70-90% of feed water exits the element in the reject stream. For instance, in household reverse osmosis systems, it can be economically and environmentally more responsible to reduce the reject stream so that less water is wasted down the sanitary sewer versus water that is produced for drinking (i.e. permeate). During fabrication and casting of the polymer layer in membrane sheet fabrication, the flux and rejection of the membrane can be adjusted by the polymer formulation during fabrication. For instance, the flux can be dramatically increased by adjustment of the chemical formulation. Likewise, the rejection of the membrane can be adjusted. In some cases, for instance, both the flux and rejection can be affected such that the flux is increased and the rejection is decreased. When these conditions exist in the finished membrane sheet, UV light exposure to the membrane sheet can improve the rejection without damaging the flux. UV light can be applied either above the active surface of the membrane, or below the active surface of the membrane. The UV light can be scanned along the length (or width) of the membrane sheet, or the membrane sheet can be drawn along a fixed position of the UV light source, or a combination thereof. UV light can also be varied along the length, or cross-ways to the membrane sheet, in order to facilitate more uniform quality of permeate by changing the rejection along or cross-ways to the membrane sheet. Membrane casting is not always a uniform process; the thickness of the polymer coating on the membrane substrate can vary. When the active coating of the membrane sheet varies in thickness, the UV light intensity can be varied to ensure the correct flux and rejection desired at any point in the membrane sheet are at the desired values. In similar fashion the UV light intensity can be varied to ensure the correct amount of UV energy is applied to photosensitive polymers that are used as spacers on the membrane sheet, spacers being applied either above or below the active membrane surface. Different wavelengths of energy can also be used, including but not limited to visible wavelengths and UV wavelengths.

### BRIEF DESCRIPTION OF DRAWINGS

FIG. 1 is a view of a conventional spiral wound membrane element prior to rolling.

FIG. 2 is a view of a membrane sheet with a UV light above the active surface of the membrane with the membrane sheet moving across the fixed position of the UV light.

FIG. 3 is a view of a membrane sheet with a UV light below the active surface of the membrane with the membrane sheet moving across the fixed position of the UV light.

FIG. 4 is a view of a membrane sheet with a UV light below the active surface of the membrane with the UV light moving relative to the fixed position of the membrane sheet.

FIG. 5 is a view of a membrane sheet with a UV light below the active surface of the membrane with printed patterns on the active surface of the membrane sheet.

FIG. 6 is a view of a membrane sheet with the intensity of UV light changing linearly along the length of the membrane sheet.

FIG. 7 is a view of a membrane sheet with the intensity of UV light changing variably along the length of the membrane sheet corresponding with the thickness of the material in the membrane sheet such that the UV intensity at the top of the membrane sheet is at the desirable value along the length of the membrane sheet.

### MODES FOR CARRYING OUT THE INVENTION AND INDUSTRIAL APPLICABILITY

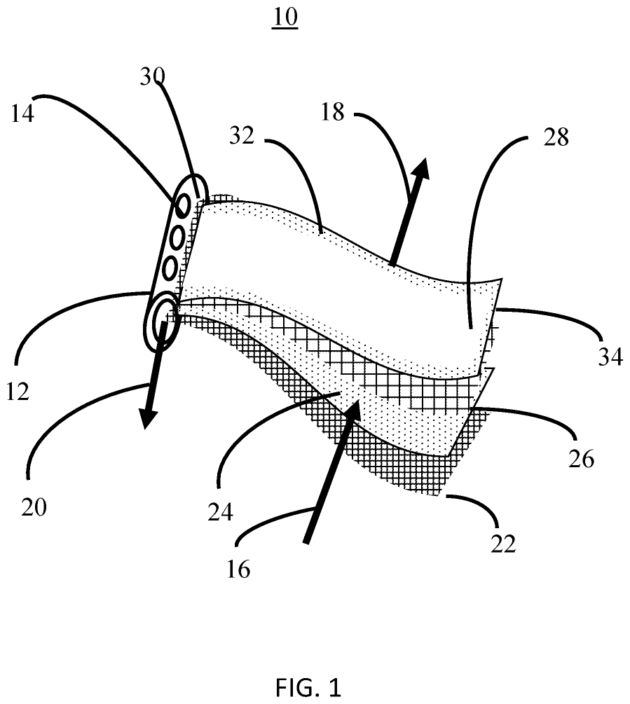

FIG. 1 is a schematic illustration of elements of a conventional spiral wound membrane element 10. Permeate collection tube 12 comprises holes 14 in collection tube 12 where permeate fluid is collected from permeate feed spacer 22. In fabrication, membrane sheets 24 and 28 comprises one sheet that is folded at center line 30. Membrane sheets 24 and 28 are typically comprised of a permeable support layer, for example polysulfone or polysulfone over polyethylene, and an active polymer membrane layer bonded or cast on to the support layer. Active polymer membrane surface 24 is adjacent to feed spacer mesh 26 and non-active support layer 28 is adjacent to permeate carrier 22. Feed solution 16 enters between active polymer membrane surfaces 24 and flows through the open spaces in feed spacer mesh 26. As feed solution 16 flows through feed spacer mesh 26, total dissolved solids (TDS) ions are rejected at active polymer membrane surfaces 24 and molecules of permeate fluid, for instance water molecules, pass through active polymer membrane surfaces 24 and enter permeable permeate carrier 22. As feed solution 16 passes along active polymer membrane surface 24, the concentration of TDS ions increases due to the loss of permeate fluid in bulk feed solution 16, and thereby exits the reject end of active polymer membrane sheet 24 as reject solution 18 with a higher TDS than feed solution 16. Permeate fluid in permeate carrier 22 flows from distal end 34 of permeate carrier 22 in the direction of center tube 12 where the permeate fluid enters center tube 12 through center tube entrance holes 14 and exits center tube 12 as permeate solution 20. To avoid contamination of the permeate fluid with feed solution 16, active polymer membrane surfaces 24 are sealed with adhesive along adhesive line 32 through permeate carrier 22 thereby creating a sealed membrane envelope where the only exit path for permeate solution 20 is through center tube 12.

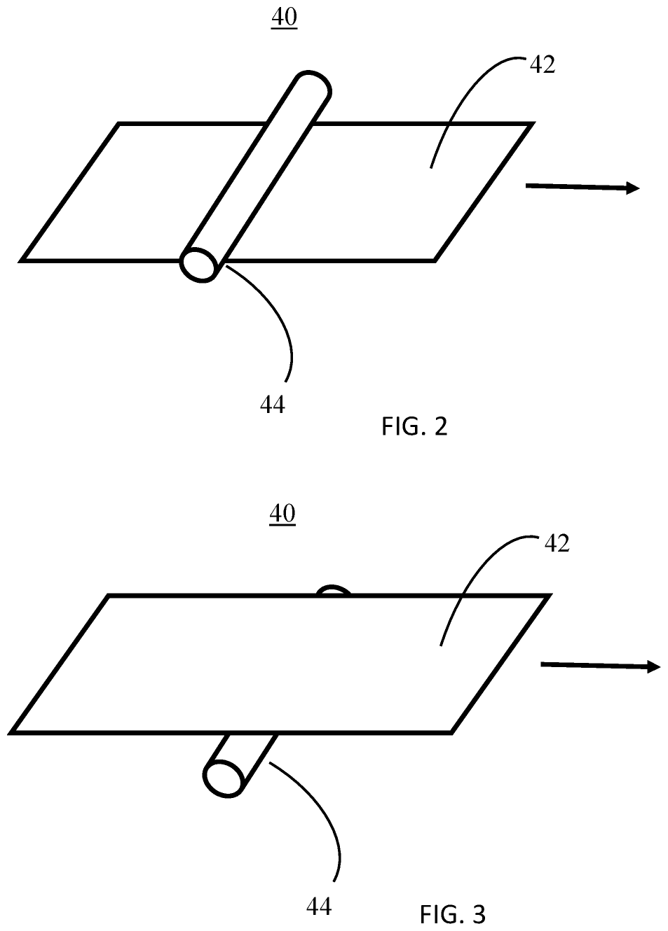

In an example embodiment of the present invention shown in FIG. 2, the characteristics of the active membrane surface on membrane sheet 42 can be formulated to create a desired flux and rejection of salt at the membrane surface. UV light can be exposed to the active membrane surface to change or optimize the flux and rejection performance of the active membrane layer. Wavelengths such as visible light can also be utilized. UV light source 44 is positioned above membrane sheet 42. Membrane sheet 42 is drawn along fixed UV source 44. The rate of motion of membrane sheet 42 can be varied as well as the intensity of UV source 44 to achieve the desired flux and rejection values for a specific application.

In an example embodiment of the present invention shown in FIG. 3, UV light source 44 is placed below membrane sheet 42 and membrane sheet 42 has some transparency to UV or visible light. Membrane sheet 42 is drawn along fixed UV source 44. The rate of motion of membrane sheet 42 can be varied as well as the intensity of UV source 44 to achieve the desired flux and rejection values for a specific application. The treatment parameters used can depend on membrane characteristics such as amine loadings, polymer coatings, and cleaning protocols; and on desired performance characteristics. The desired properties of the membrane can include rejection (the amount or percentage of sale rejected at the membrane surface) and flux (the amount of fluid passing through the membrane surface in a given area of membrane surface). Rejection and flux can depend on the active surface after treatment. Those skilled in the art are familiar with the various dependencies involved and can select treatment parameters based on the specific membrane in use and the desired properties for the application.

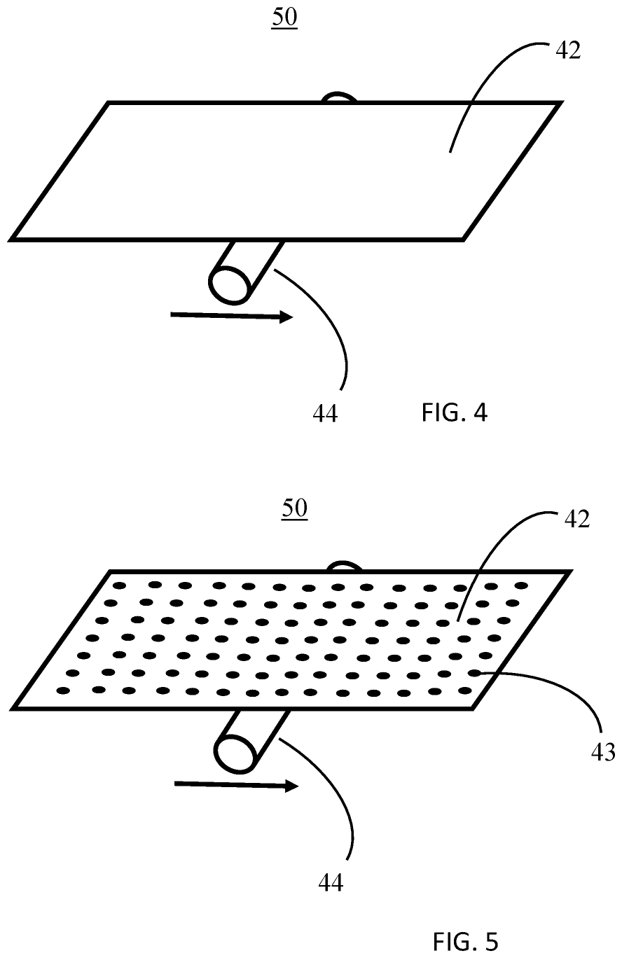

In an example embodiment of the present invention shown in FIG. 4, UV light source 44 is placed below membrane sheet 42 and membrane sheet 42 has some transparency to UV or visible light. UV source 44 is drawn along membrane sheet 42. The rate of motion of UV source 44 can be varied as well as the intensity of UV source 44 to achieve the desired flux and rejection values for a specific application.

In an example embodiment of the present invention shown in FIG. 5, feed spacers 43 can be applied on the active surface of membrane sheet 42 to create a fluid feed channel for the flow of feed solution across the surface of membrane sheet 42. Spacers can also be applied on the bottom side of membrane sheet 42 such that feed spaces are created on the active surface of membrane sheet 42 by virtue of applying pressure in the feed space and embossing membrane sheet 42 over the spacers when pressure is applied to the feed solution. With the appropriate energy intensity of UV light applied by UV light source 44, photopolymer spacers can be hardened, and at the same time the flux and rejection characteristics of the membrane can be modified. Feed spacers 43 can be applied by direct printing of photopolymer on the membrane sheet, by offset printing, by screed printing, by gravure printing, or other techniques that may apply the spacing material to membrane sheet 42.

In an example embodiment of the present invention shown in FIG. 6, the intensity of UV source 44 can be varied along either or both of the linear or transverse directions of membrane sheet 42 to vary the flux and rejection characteristics of the membrane sheet at any location on membrane sheet 42. For example, as feed solution flows along the surface of membrane sheet 42 salt ions are rejected and the concentration of salt at the membrane surface will increase. It can be desirable to have increased flux or improved rejection characteristics at these areas of membrane sheet 42 to improve the overall performance of the membrane element or system. These performance characteristics can be advantageous for conventional membrane elements, and for membrane elements with feed flow along the long length of the membrane sheet in order to improve recovery (ratio of permeate to feed solution) in elements such as those manufactured by Pentair Corporation under the name GRO, or for membrane systems such as pressure retarded osmosis or forward osmosis.

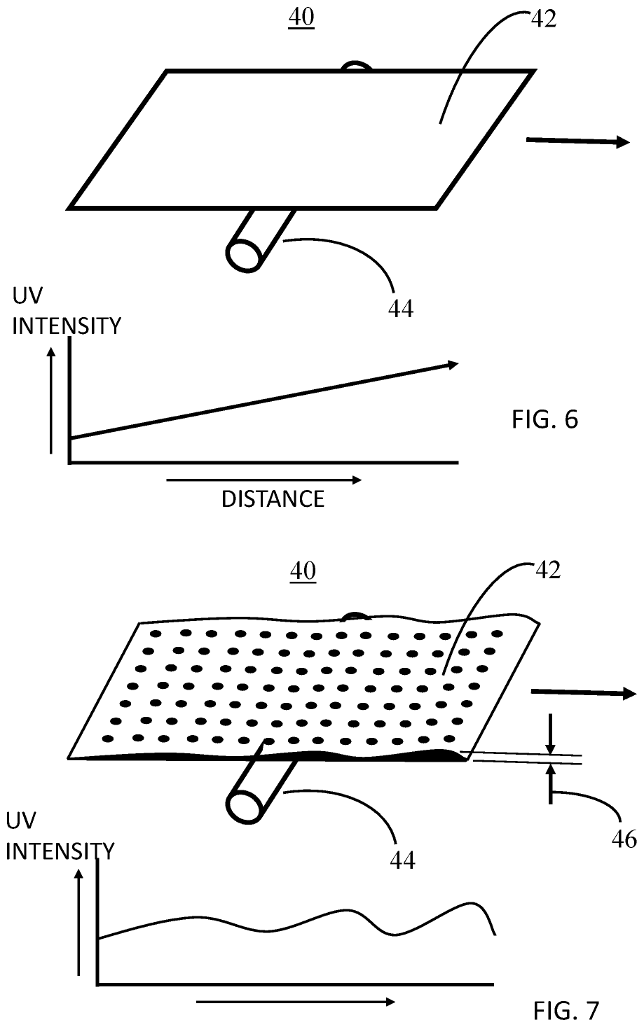

In an example embodiment of the present invention shown in FIG. 7, membrane sheet 42 can have thickness or translucence variations 46 in the construction of membrane sheet 42. These variations can be compensated for by changing the wavelength or energy intensity of UV source 44 as membrane sheet 42 passes along UV source 44, or as UV source 44 passes along membrane sheet 42, depending on construction of the UV exposure apparatus. The energy intensity can be varied longitudinally, laterally, or both, across the surface of membrane sheet 42. The energy intensity can be optimized for solidifying the photopolymer spacers, or for optimizing the flux or rejection characteristics of membrane sheet 42, or combinations thereof.

The present invention has been described in connection with various example embodiments. It will be understood that the above descriptions are merely illustrative of the applications of the principles of the present invention, the scope of which is to be determined by the claims viewed in light of the specification. Other variants and modifications of the invention will be apparent to those skilled in the art.

1. A method of producing a membrane comprising:
(a) providing a permeable support layer sheet;
(b) disposing a polymer coating on a first surface of the permeable support layer sheet, where the polymer coating has one or more properties that can be varied by exposure to light;
(c) supplying light to the polymer coating at wavelengths and intensities to produce a membrane having flux and rejection properties desired for use in a spiral wound filtration element.

2. The method of claim 1, wherein step (c) comprises directing light toward the permeable support layer sheet from the side of the first surface, such that the light reaches the polymer coating before reaching the permeable support layer sheet.

3. The method of claim 1, wherein step (c) comprises directing light toward the permeable support layer sheet from opposite the side of the first surface, such that the light reaches the polymer coating after transiting the permeable support layer sheet.

4. The method of claim 1, wherein step (c) comprises providing a source of light at a fixed location, and moving the permeable support layer sheet relative to the source of light.

5. The method of claim 1, wherein step (c) comprises providing a source of light at a location that is moveable relative to the permeable support layer sheet, and moving the source of light relative to the permeable support layer sheet.

6. The method of claim 1, wherein step (c) comprises supplying light having intensity, wavelength, or both, that vary with region of the membrane.

7. The method of claim 6, wherein the polymer coating has a thickness, and wherein step (c) comprises supplying light having intensity, wavelength, or both, that vary responsive to the thickness of the polymer coating.

8. The method of claim 6, wherein step (c) comprises supplying light having intensity, wavelength, or both, that is constant across a first dimension of the membrane and vary along a second dimension of the membrane.

9. The method of claim 6, wherein the membrane sheet has a thickness, and wherein step (c) comprises supplying light having intensity, wavelength, or both, that vary responsive to the thickness of the membrane sheet.

10. The method of claim 6, wherein step (c) comprises supplying light such that the flux of the membrane has a first value near a first end or side of the membrane and a second value near a second, opposite, end or side of the membrane, wherein the second value is greater than the first value.

11. The method of claim 10, wherein the flux of the membrane varies smoothly from the first value to the second value between the first and second ends or sides.

12. The method of claim 6, wherein step (c) comprises supplying light such that the rejection of the membrane has a first value near a first end or side of the membrane and a second value near a second end or side of the membrane, opposite the first end or side of the membrane, wherein the second value is greater than the first value.

13. The method of claim 10, wherein the rejection of the membrane varies smoothly from the first value to the second value between the first and second ends or sides.

14. (canceled)

15. The method of claim 1, wherein the light comprises ultraviolet light.

16. A membrane for use in a spiral wound filtration element, having a flux or rejection that has a first value near a first end or side of the membrane and a second value near a second, opposite, end or side of the membrane, wherein the second value is greater than the first value.

17. The membrane of claim 16, wherein the flux or rejection of the membrane varies smoothly from the first value to the second value between the first and second ends or sides.

18. The membrane of claim 16, having a flux that has a first flux value near a first end or side of the membrane and a second flux value near a second, opposite, end or side of the membrane, wherein the second flux value is greater than the first flux value; and having a rejection that has a first rejection value near a first end or side of the membrane and a second rejection value near a second, opposite, end or side of the membrane, wherein the second rejection value is greater than the first rejection value.
